(19) United States
(12) Patent Application Publication
(10) Pub. No.: US 2005/0123159 A1
(43) Pub. Date: Jun. 9, 2005

(54) Portable accoustic apparatus

(76) Inventors: Bunkei Matsuoka, Tokyo (JP); Yasutaka Mizutani, Tokyo (JP)

Correspondence Address: BIRCH STEWART KOLASCH & BIRCH, PO BOX 747, FALLS CHURCH, VA, 22040-0747, US

(21) Appl. No.: 10/507,422

(22) PCT Filed: Dec. 24, 2003
(86) PCT No.: PCT/JP03/16607

(30) Foreign Application Priority Data
Jan. 14, 2003 (JP) 2003-6038

(51) Int. Cl. H04R 25/00

(52) U.S. Cl. 381/312

(57) ABSTRACT

A portable acoustic apparatus includes a sound outlet (3) formed in the front wall (61) of a housing (6); an acoustic converting element (1) fixed in the housing in such a manner that a front chamber (2) is formed between the acoustic converting element and the front wall (61), and a back chamber (4) is formed between the acoustic converting element and the back wall (62) of the housing (6); and a duct (5) that is formed in the front wall (61) around the sound outlet (3) and communicates to the outside of the housing. The minimum inner width W of the outer casing (63) of the housing (6) is made equal to or less than the standard diameter of the human concha.

### TECHNICAL FIELD

The present invention relates to a portable acoustic apparatus such as a mobile phone with which a user listens by coupling its sound outlet to a concha.

### BACKGROUND ART

An acoustic receiving component is known which is mounted on a portable acoustic apparatus such as a mobile phone, compact radio communication apparatus, compact portable radio and compact recorder, to serve as a receiver (earpiece) or speaker for receiving a sound signal by an acoustic converting element and converting it into sounds such as speech and music to be output. To receive sounds by the portable acoustic apparatus employing the acoustic receiving component, a user couples a sound outlet (also called an earpiece in a mobile phone) mounted on the housing of the apparatus to his or her concha. Generally, to mount the acoustic receiving component on the portable acoustic apparatus, a sufficient capacity must be provided in the back portion of the diaphragm (back chamber) of the acoustic converting element. Otherwise, there is a problem of increasing the stiffness (inverse of the capacitance) of the vibration system and deteriorating the output sound pressure characteristics, particularly in lower frequencies. This is because the resonance frequency f0 of the entire vibration system including the acoustic converting element is inversely proportional to the square root of the product of the equivalent mass and equivalent capacitance of the vibration system. However, it is difficult for the compact acoustic apparatus intended for portable use in general to provide a large back chamber because of the restriction of the mounting capacity. In addition, as for the acoustic receiving component applied to the compact acoustic apparatus, a small diameter acoustic converting element is mounted to match the size of the acoustic apparatus. Such a small-diameter acoustic converting element, however, shows a tendency of reducing the mass and increasing the stiffness of the vibration system including the diaphragm as compared with a larger diameter acoustic converting element. Thus, the minimum resonance frequency f0 of the acoustic receiving component itself has a tendency to increase.

To solve the problem, the technique is widely known which tries to improve the characteristics in the lower frequencies by providing the back of the back chamber with a vent (sound outlet) communicating to the outside of a housing containing the acoustic receiving component, and by reducing the minimum resonance frequency f0 of the entire acoustic vibration system including the diaphragm by adding and adjusting the acoustic mass caused by the back vent without increasing the capacity of the back chamber. In addition, a method of expanding the reproduction frequency band by adjusting the acoustic resistance that is inserted because of providing the sound outlet. Techniques of improving the low frequency characteristics by utilizing the foregoing findings for the headphones that are called inner ear headphones, are disclosed in Japanese patent application laid-open Nos. 1-166696/1989, 61-123300/1986, 7-170590/1995, 7-170591/1995, and 8-172691/1996.

These inner ear headphones differ in their usage from the portable acoustic apparatus which is the target of the present invention. However, to help understanding of the present invention, the structure and characteristics disclosed in Japanese patent application laid-open No. 1-166696/1989 will be described here.

FIG. 6 is a cross-sectional view showing a schematic structure of an auditory canal type headphone described in the foregoing document, FIGS. 7A and 7B are schematic diagrams showing its coupling state, and FIG. 8 is a circuit diagram showing an acoustic equivalent circuit corresponding to its acoustic structure.

Referring to FIG. 6, a housing 6 composed of a porous material in part includes an acoustic converting element 1 in such a manner that it faces a sound outlet 3 of the housing 6 and forms a front chamber 2. At the back of the acoustic converting element 1, a back chamber 4 is provided between the back and the housing 6. In addition, at the back of the housing 6, a low frequency characteristic correcting duct 50 communicating to the back chamber 4 is provided.

As shown in FIG. 8, the acoustic equivalent circuit of the foregoing structure includes a circuit 10 represented by a signal source V, an equivalent acoustic resistance R0 and an equivalent acoustic mass M0 of the mechanical vibration system of the acoustic converting element 1, and an equivalent acoustic capacitance C0 including the acoustic capacitance of the front chamber 2 as its integral part. In addition, the acoustic equivalent circuit has an acoustic capacitance Cb of the back chamber 4, an acoustic mass Md of the low frequency characteristic correcting duct 50, and an acoustic resistance Rd produced by forming part of the housing 6 by the porous material. Furthermore, the acoustic equivalent circuit has an acoustic capacitance Cf in the auditory canal 22 in the case where the headphone is fitted into the auditory canal 22 as shown in FIGS. 7A and 7B, an acoustic resistance Rr and an acoustic mass Mr produced by the minute gap between the housing 6 and auditory canal 22.

In such a headphone, the acoustic mass Md provided by forming the duct 50 and the acoustic resistance Rd produced by forming part of the housing 6 by the porous material are each placed in parallel with the acoustic capacitance Cb of the back chamber 4. Accordingly, as in the foregoing findings, the minimum resonance frequency f0 of the entire acoustic vibration system is reduced because the vibration system has in its entirety the acoustic mass Md of the duct 50 added to the equivalent acoustic mass M0 of the acoustic converting element 1 without varying the acoustic capacitance Cb of the back chamber 4. In addition, the acoustic resistance Rd connected in parallel with the acoustic mass Md, which is produced by forming part of the housing 6 with the porous material, reduces Q of the resonance system as it increases, thereby increasing the reproduction bandwidth, but reducing the sound pressure in the low and middle frequencies. On the contrary, when the acoustic resistance Rd is small, the Q of the resonance system becomes large, which narrows the reproduction bandwidth with increasing the sound pressure near the minimum resonance frequency f0. As a result, the headphone offers an advantage of being able to reduce the lower limit of the reproduction frequency by forming the duct 50, and to facilitate the adjustment of the balance between the sound pressure and the bandwidth, because the acoustic mass Md and acoustic resistance Rd are controllable independently.

As for the techniques described in the other documents described above, they are the same as the technique disclosed in Japanese patent application laid-open No. 1-166696/1989 in that they try to reduce the resonance frequency of the entire vibration system by providing the acoustic mass and acoustic resistance to the back chamber 4 in the inner ear headphone which is inserted into the auditory canal. They only modify the way of providing the acoustic mass Md and acoustic resistance Rd.

The headphone of the type inserted into the auditory canal 22 is almost always designed such that the coupling portion between the auditory canal 22 and housing 6 is nearly enclosed. In this case, the acoustic capacitance Cf of the space enclosed by the housing 6 and the auditory canal 22 is very small of about 2 cc in terms of the capacity, and constitutes a nearly fixed capacity. The housing 6 has a minute gap between it and the auditory canal 22 depending on the shape and material of the housing 6. The major component of the acoustic resistance Rr is a viscous drag because of the leakage through the gap. Summing up the relatively large acoustic resistance Rr produced by the viscous drag, the minute acoustic mass Mr and the small acoustic capacitance Cf results in a very high acoustic impedance. Besides, the acoustic resistance Rr and the acoustic mass Mr, and the acoustic capacity Cf in the auditory canal bring about an effect equivalent to a high-pass filter depending on their relationships, and hence have characteristics of cutting low frequencies as compared with the case where no gap is present. In any case, the inner ear headphone assumes that the coupling conditions (and the acoustic capacity Cf, acoustic resistance Rr and acoustic mass Mr in connection with it) are nearly fixed regardless of its user. Thus, the inner ear headphone is characterized by the fact that the acoustic mass Md produced by the duct 50 and the acoustic resistance Rd caused by the housing 6 can be fixedly set in advance.

As described above, the inner ear headphone assumes only the case where the auditory canal 22 and the housing 6 has a very tight coupling (almost no gap is present, or the gap is very small even if it is present). Consequently, the conditions of the acoustic mass Md caused by the duct 50 and the acoustic resistance Rd caused by the housing 6, which are to be set in the back chamber 4, can be almost uniquely determined once the conditions of the vibration system of the acoustic converting element 1 and the conditions of the coupling between the auditory canal and housing 6 are determined. Therefore the insertion positions of the acoustic mass Md and the acoustic resistance Rd can be uniquely determined at the back of the diaphragm.

Although the conventional headphone has the foregoing structure, it presents the following problem when applied to the portable acoustic apparatus such as a mobile phone. When a user couples the sound outlet of the portable acoustic apparatus to his or her ear, a gap always occurs between the concha and the housing of the portable acoustic apparatus. In this case, a problem arises in that variations in the acoustic capacity Cf, acoustic resistance Rr and acoustic mass Mr caused by the coupling are directly reflected in the frequency characteristics depending on the usage conditions that depend on the user and coupling position of the housing of the acoustic receiving component. The problem cannot be prevented by only providing the back chamber with the fixed acoustic mass Md and acoustic resistance Rd, and by inserting them in series with the vibration system (in a single loop).

FIG. 4 is a front view of a human ear. It is known that a human concha 23 is generally approximated by a hollowed cylinder with a diameter of 25 mm (referred to as a standard diameter from now on). Consequently, it is very likely that stable coupling between the concha 23 and the housing can be achieved without a gap, when the portable acoustic apparatus used by coupling to the concha 23 has the housing that has a periphery portion greater than the standard diameter of the human concha about the sound outlet. In this case, the conditions of the acoustic mass Md caused by the duct provided in the back chamber and of the acoustic resistance Rd caused by the housing can be determined uniquely in the same manner as the inner ear headphone to be inserted into the auditory canal.

The present invention is implemented to solve the foregoing problem. Therefore it is an object of the present invention to provide portable acoustic apparatus capable of reducing the minimum resonance frequency of the vibration system, that is, of the acoustic converting element, and at the same time capable of always providing frequency characteristics with small characteristic variations without depending on the coupling conditions.

### DISCLOSURE OF THE INVENTION

According to an aspect of the present invention, there is provided a portable acoustic apparatus from which a user receives sound by coupling it to a concha, the portable acoustic apparatus comprising: a sound outlet provided in a front wall of a housing of the portable acoustic apparatus; an acoustic converting element fixed in the housing such that a front chamber is formed between the acoustic converting element and the front wall, and a back chamber is formed between the acoustic converting element and a back wall of the housing; and a duct that is provided in the front wall around the sound outlet, and that communicates to an outside of the housing, wherein a minimum inner width of an outer casing of the housing is set at a value equal to or less than a standard diameter of a human concha.

Thus, it offers an advantage of being able to reduce the minimum resonance frequency f0 of the vibration system, that is, of the acoustic converting element, when the portable acoustic apparatus is used with being coupled to the concha, and able to provide the stable frequency characteristics with small characteristic variations regardless of the coupling conditions.

### BRIEF DESCRIPTION OF THE DRAWINGS

FIGS. 1A and 1B are structural views showing a partial structure of a portable acoustic apparatus of an embodiment 1 in accordance with the present invention;

FIGS. 2A and 2B are diagrams illustrating a usage state of the portable acoustic apparatus of the embodiment 1 in accordance with the present invention;

FIG. 3 is a circuit diagram showing an acoustic equivalent circuit of the embodiment 1 in accordance with the present invention;

FIG. 4 is an illustrative front view showing a human ear;

FIGS. 5A and 5B are diagrams illustrating a usage state of a portable acoustic apparatus of an embodiment 2 in accordance with the present invention;

FIG. 6 is a cross-sectional view schematically showing a structure of a conventional auditory canal type headphone;

FIGS. 7A and 7B are schematic diagrams illustrating a worn state of the conventional headphone; and

FIG. 8 is a circuit diagram showing an acoustic equivalent circuit corresponding to the acoustic structure of the conventional headphone.

### BEST MODE FOR CARRYING OUT THE INVENTION

The best mode for carrying out the invention will now be described with reference to the accompanying drawings to explain the present invention in more detail.

### EMBODIMENT 1

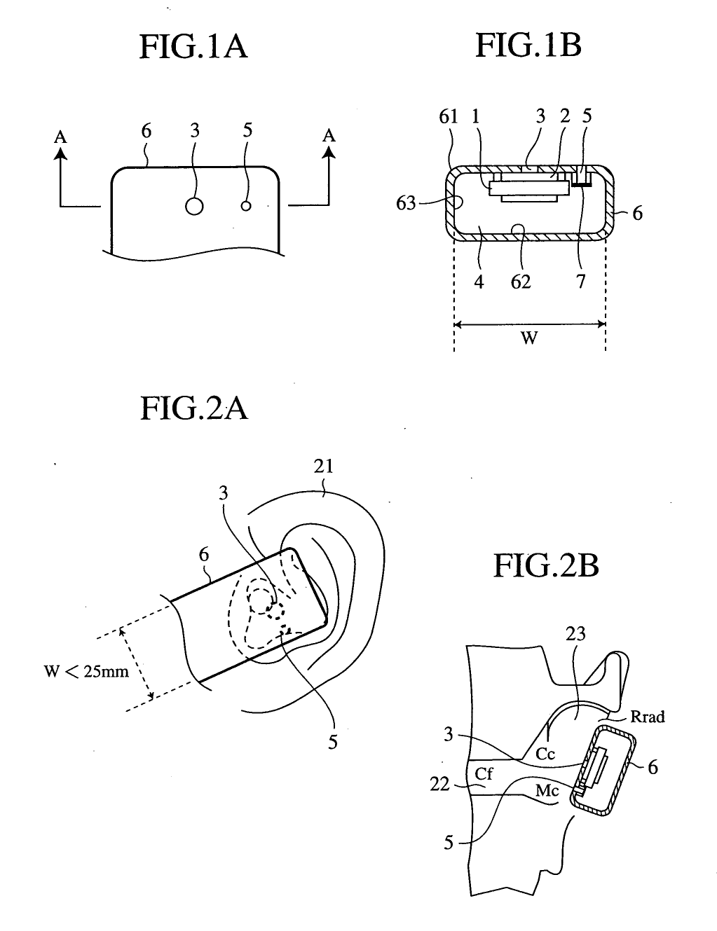

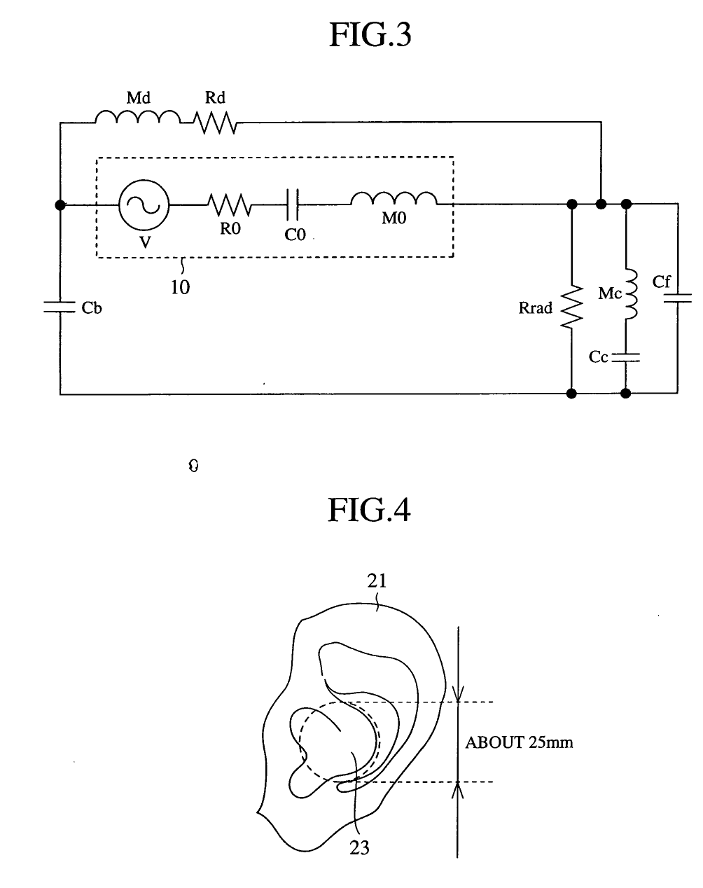

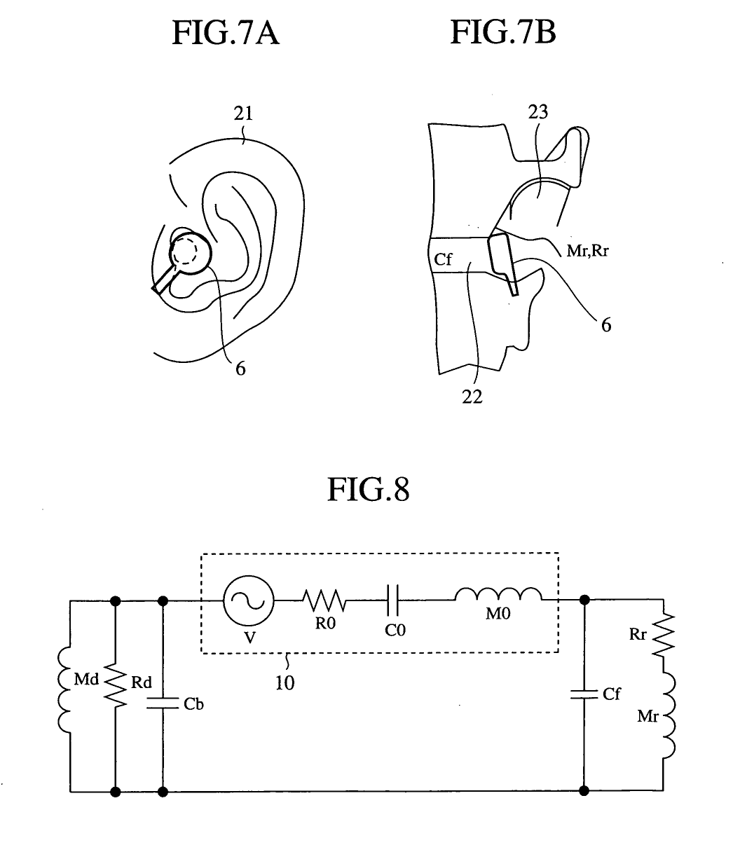

FIGS. 1A and 1B are a front view and a cross-sectional view showing a partial structure of a portable acoustic apparatus of an embodiment 1 in accordance with the present invention. FIGS. 2A and 2B are diagrams illustrating a usage state of the portable acoustic apparatus as shown in FIGS. 1A and 1B, and FIG. 3 is a circuit diagram showing an acoustic equivalent circuit corresponding to FIGS. 1A and 1B, and FIGS. 2A and 2B. In these figures, the same reference numerals as those of FIGS. 6-8 designate the same or like portions.

FIGS. 1A and 1B show an acoustic converting element 1 attached to the inside of a sound outlet 3 of the housing 6 of the portable acoustic apparatus. The housing 6 has a cylindrical or hollowed prism-like outer casing 63, the minimum internal width W of which is set at a size smaller than the standard diameter of the human concha. The front wall 61 of the housing 6 has the sound outlet 3. The acoustic converting element 1 is fixed in the housing 6 in such a manner that it faces the sound outlet 3 with forming a front chamber 2 between it and the front wall. At the back of the acoustic converting element 1, a specified back chamber 4 is provided between the acoustic converting element 1 and the back wall 62 of the housing 6. In addition, in the front wall 61 of the housing 6, a low frequency characteristic correcting duct 5 is provided within a periphery with a radius of 12.5 mm (half the standard diameter of the concha) about the sound outlet 3 in such a manner that it joins to the back chamber 4 and communicates to the outside of the housing. The duct 5 has its opening at the inner side of the housing stuck with an acoustic resistance cloth (acoustic resistance material) 7 in such a manner that it covers the duct 5 to increase the acoustic resistance.

FIG. 2A illustrates a state in which the portable acoustic apparatus including the acoustic receiving component is coupled to the ear, and FIG. 2B illustrates the positional relationship between the housing 6 and the concha 23.

In FIG. 3, the acoustic equivalent circuit includes a series connection of a signal source V, an equivalent acoustic resistance R0 and an equivalent acoustic mass M0 of the mechanical vibration system of the acoustic converting element 1, and an equivalent acoustic capacitance C0 including the acoustic capacitance of the front chamber 2 as its integral part. In addition, the acoustic capacitance Cb of the back chamber 4 has an acoustic mass Md of the low frequency characteristic correcting duct 5 and an acoustic resistance Rd caused by the acoustic resistance cloth 7 stuck to the duct 5. Rrad is a radiation impedance when sound is radiated from the gap between the housing 6 and concha 23 in FIGS. 2A and 2B. The radiation impedance Rrad is approximated by a constant resistance value when the gap is rather large (with a width of 1-2 mm or more) even if the gap increases beyond that. In addition, there are acoustic capacitance Cf in the auditory canal, and the acoustic capacitance Cc and acoustic mass Mc in the portion covered with the housing 6 and concha.

Next, the operation of the present embodiment 1 will be described with reference to the acoustic equivalent circuit of FIG. 3.

The acoustic mass Md caused by the duct 5 joined to the back chamber 4, and the acoustic resistance Rd caused by the acoustic resistance cloth 7 are directly connected to the acoustic impedance caused by the concha 23. As a result, a feedback circuit is formed from the sound outlet 3 to the back chamber 4 via the duct 5. Thus, the entire vibration system includes two independent loops: a first loop including the acoustic mass Md and acoustic resistance Rd; and a second loop including the radiation impedance Rrad, the acoustic mass Cf in the auditory canal, and the acoustic capacitance Cc and acoustic mass Mc of the concha 23 (Cc and Mc constitute the effective load impedance of the concha). In this case, the radiation impedance Rrad is not varied so much by the coupling manner of the housing 6 to the concha 23. In contrast, the acoustic capacitance Cf in the auditory canal 22, and the acoustic capacitance Cc and acoustic mass Mc of the concha vary readily and greatly. However, the loop including the Md and Rd is rather insensitive to the variations in the Cc and Mc because the variations in the radiation impedance Rrad is small. In other words, inserting the Md and Rd into the independent loop makes it possible to reduce the minimum resonance frequency of the entire system, and to achieve good frequency characteristics all the time without any large variations in the characteristics in spite of the variations in the load impedance because of the changes in the coupling conditions.

As described above, the present embodiment 1 is configured such that the minimum inner width W of the outer casing 63 of the housing 6 of the portable acoustic apparatus is determined at a value less than the standard diameter of the human concha, and that the duct 5 communicating to the outside of the housing is provided in the front wall 61 around the sound outlet 3, thereby forming the acoustic mass and acoustic resistance for reducing the minimum resonance frequency of the acoustic converting element 1. Consequently, the present embodiment 1 offers an advantage of being able to reduce the minimum resonance frequency f0 of the vibration system, that is, of the acoustic converting element, when the user uses the portable acoustic apparatus with coupling it to the concha, and to provide the stable frequency characteristics regardless of the coupling conditions.

In addition, the present embodiment 1 has the duct 5 located within half the standard diameter of the human concha from the sound outlet 3. Accordingly, when the user uses the portable acoustic apparatus with coupling it to the concha, both the sound outlet 3 and the duct 5 are located within the concha of the user, thereby being able to positively generate the acoustic mass and acoustic resistance for reducing the minimum resonance frequency of the acoustic converting element 1. Furthermore, the present embodiment 1 has the acoustic resistance cloth 7 at the opening of the duct 5 on the inner side of the housing, which offers an advantage of being able to increase the acoustic resistance of the duct 5.

### EMBODIMENT 2

The foregoing embodiment 1 assumes that the minimum inner width of the rectangular outer casing of the housing 6 is less than the standard diameter of the human concha. In the present embodiment 2, it will be described that a housing with a minimum inner width equal to or greater than the standard diameter can function as that of the foregoing embodiment 1.

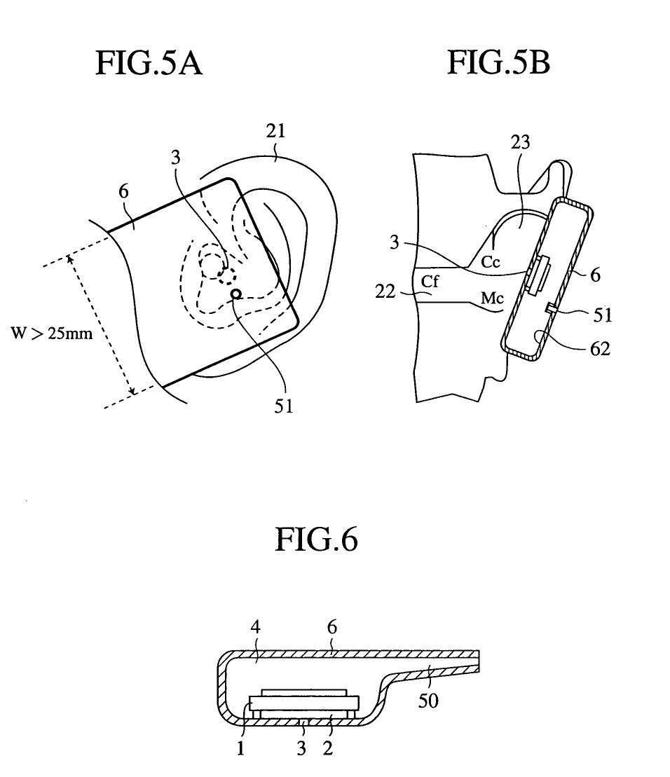

FIGS. 5A and 5B are diagrams illustrating a usage state of the portable acoustic apparatus of the embodiment 2 in accordance with the present invention. Its internal structure will be described with reference to FIGS. 1A and 1B. The minimum inner width W of the outer casing 63 of the housing 6 is assumed to be equal to or greater than the standard diameter of the human concha of 25 mm. In addition, the distance between the center of the sound outlet 3 and the outer casing 63 of the housing 6 is made less than half the standard diameter of 12.5 mm at some part. Furthermore, a duct 51 communicating to the outside of the housing is formed in the back wall 62 around the sound outlet 3. The portable acoustic apparatus with such a structure can implement the same coupling conditions and acoustic equivalent circuit as the embodiment 1. Besides, the acoustic resistance cloth 7 for increasing the acoustic resistance of the duct 51 can be provided at the opening of the duct 51 at the internal side of the housing.

As described above, the present embodiment 2 is configured such that the minimum inner width W of the outer casing 63 of the housing 6 of the portable acoustic apparatus is made equal to or greater than the standard diameter of the human concha, that the distance between the center of the sound outlet and the inner wall of the outer casing 63 is made less than half the standard diameter in some part, and that the duct 51 communicating to the outside of the housing is formed in the back wall 62 around the sound outlet 3 to form the acoustic mass and acoustic resistance for reducing the minimum resonance frequency of the acoustic converting element 1. Consequently, as the foregoing embodiment 1, the present embodiment 2 offers an advantage of being able to reduce the minimum resonance frequency f0 of the vibration system, that is, of the acoustic converting element, when the portable acoustic apparatus is used with coupling it to the concha, and to provide the stable frequency characteristics with little characteristic variations regardless of the coupling conditions. In addition, the present embodiment 2 has the duct 51 located within half the standard diameter of the human concha from the sound outlet 3. Accordingly, when the user uses the portable acoustic apparatus with coupling it to the concha, both the sound outlet 3 and the duct 51 are located within the concha of the user, thereby being able to positively generate the acoustic mass and acoustic resistance for reducing the minimum resonance frequency of the acoustic converting element 1. Furthermore, the present embodiment 2 has the acoustic resistance cloth 7 at the opening of the duct 51 on the inner side of the housing, which offers an advantage of being able to increase the acoustic resistance of the duct 51.

### INDUSTRIAL APPLICABILITY

The mobile phones have been spreading remarkably recently, but their coupling state to the auditory canal of users vary from person to person. The portable acoustic apparatus in accordance with the present invention can achieve stable frequency characteristics with small variations regardless of the coupling conditions. Therefore it can be expected that it achieves considerable effect when applied to mobile phones.

1. A portable acoustic apparatus from which a user receives sound by coupling it to a concha, said portable acoustic apparatus comprising:
a sound outlet provided in a front wall of a housing of said portable acoustic apparatus;
an acoustic converting element fixed in said housing such that a front chamber is formed between said acoustic converting element and said front wall, and a back chamber is formed between said acoustic converting element and a back wall of said housing; and
a duct that is provided in said front wall around said sound outlet, and that communicates to an outside of said housing, wherein
a minimum inner width of an outer casing of said housing is set at a value equal to or less than a standard diameter of a human concha.

2. The portable acoustic apparatus according to claim 1, wherein said duct is formed at a location within half the standard diameter of the human concha from said sound outlet.

3. The portable acoustic apparatus according to claim 1, further comprising an acoustic resistance material for increasing an acoustic resistance of said duct at an opening of said duct at an internal side of said housing.

4. The portable acoustic apparatus according to claim 2, further comprising an acoustic resistance material for increasing an acoustic resistance of said duct at an opening of said duct at an internal side of said housing.

5. A portable acoustic apparatus from which a user receives sound by coupling it to a concha, said portable acoustic apparatus comprising:
a sound outlet provided in a front wall of a housing of said portable acoustic apparatus;
an acoustic converting element fixed in said housing such that a front chamber is formed between said acoustic converting element and said front wall, and a back chamber is formed between said acoustic converting element and a back wall of said housing; and
a duct that is provided in said front wall around said sound outlet, and that communicates to an outside of said housing, wherein
a minimum inner width of an outer casing of said housing is set at a value equal to or greater than a standard diameter of a human concha, and
a distance between the center of said sound outlet and an internal side of said outer casing is less than half the standard diameter at least in some part.

6. The portable acoustic apparatus according to claim 5, wherein said duct is formed at a location within half the standard diameter of the human concha from said sound outlet.

7. The portable acoustic apparatus according to claim 5, further comprising an acoustic resistance material for increasing an acoustic resistance of said duct at an opening of said duct at an internal side of said housing.

8. The portable acoustic apparatus according to claim 6, further comprising an acoustic resistance material for increasing an acoustic resistance of said duct at an opening of said duct at an internal side of said housing.
